(19) United States
(12) Patent Application Publication
(10) Pub. No.: US 2019/0369749 A1
(43) Pub. Date: Dec. 5, 2019

(54) OBJECT CONTROLLER

(71) Applicant: Yoo Jung HONG, Yongin-si (KR)

(72) Inventor: Yoo Jung HONG, Yongin-si (KR)

(21) Appl. No.: 16/340,914

(22) PCT Filed: Oct. 10, 2017
(86) PCT No.: PCT/KR2017/011117

§ 371 Date: May 22, 2019

(30) Foreign Application Priority Data
Oct. 10, 2016 (KR) 10-2016-0130885
May 31, 2017 (KR) 10-2017-0067832

(51) Int. Cl. G06F 3/0346; G05D 1/00

(52) U.S. Cl. CPC G06F 3/0346; A63F 13/24; G06F 2203/0384; G05D 1/0011

(57) ABSTRACT

The present invention relates to an object controller capable of controlling a movement and a rotation of an object. The present invention provides an object controller capable of controlling a motion of an object, the object controller including: a main body; an operating unit which is in non-contact with the main body; and a control unit which controls a motion of the object based on a relative position of the operating unit to the main body.

### TECHNICAL FIELD

The present invention relates to an object controller, and more particularly, to an object controller which can be easily and intuitively operated and can be suitably employed for controlling various objects.

### BACKGROUND ART

A controller for remotely controlling an object such as a drone, unmanned vehicle, robot, gaming device, or model car is commercially available. Generally, a remote controller includes at least one stick or button, and an operation signal generated by the stick or button is transmitted to a receiver in a control target object through a transmitter mounted in the controller.

FIG. 1 is a conceptual view illustrating an embodiment of an existing control device.

Referring to FIG. 1, forward and rearward movements, left and right movements, left and right turning, and upward and downward movements of the drone may be controlled by using both left and right sticks. However, this control method is hard to grasp on an intuitive basis, and as a result, the user needs excessive practice so as to easily control the drone.

Particularly, in the case of a controller for controlling a drone or other similar devices, the complexity of a control method employed for the controller is continuously increasing as the drone is developed for performance requiring precise control, such as stunt flying. Such a controller is not suitable for controlling various objects due to the operating difficulties.

Meanwhile, various remote controllers such as a wireless mouse, a game pad, and a move controller for remotely controlling objects in a computer program implemented on a device such as a computer or a game console are commercially available. Such a controller may be similar to the remote controller described above with reference to FIG. 1 in the aspect that the controller controls the motion of a control target object remotely even when the controller does not control a physical object such as a drone.

Controllers such as the wireless mice and game consoles are mostly gripped by a user's hands to move on a planar basis regardless of differences in shapes, sizes, and designs thereof while generating control signals by using the motion of wrists and/or arms of the user. Particularly, in case of a wireless mouse, a laser sensor mounted on the lower side detects a relative movement with respect to the surface, and this displacement is computed and transmitted as an operation signal of a pointer on the display screen. However, most of such controllers only control an object on a two-dimensional screen and the application of such controllers does not expand to fields beyond the two-dimensional screen.

Recently, an operation recognition controller for remotely controlling an object in a three-dimensional space has been proposed and applied as an input device for operations such as virtual reality (VR) gaming. The motion recognition controller is a controller which enables a user to operate in a game or execute other operations by sensing user motion and may be configured to operate in a scheme of being held in hands and moved in various directions.

Unlike the existing controller which has an operation scheme difficult for a user to get familiar with, the motion recognition controller comes with a great advantage in that the user can enjoy gaming simply by holding and moving the same. However, the motion recognition controller is mostly only for performing specific motion in a specific game. Also, since the recently proposed motion recognition controller only operates in combination with known sensors such as an accelerometer sensor and a gyroscope sensor, there exists limitations on fine and precise motion control as well as difficulties in standardization and application of the control of various objects.

As a result, the need for an object controller, which can be easily and intuitively controlled by users who are not otherwise trained in the operation of the controller and be suitably applied for controlling various objects, is emerging as the fields of controller application expand.

### DISCLOSURE

### Technical Problem

The present invention has been made during the above-described research process, and an object of the present invention is to provide an object controller which can be easily controlled with one hand instead of being controlled only while being held by both hands of a user.

In addition, the provided object controller can be appropriately employed for operations for controlling various objects while being operated in a more convenient and intuitive manner.

Technical problems of the present invention are not limited to the aforementioned technical problems, and other technical problems, which are not mentioned above, may be clearly understood by those skilled in the art from the following descriptions.

### Technical Solutions

To solve the aforementioned technical problems, an object controller capable of controlling a motion of an object according to an exemplary embodiment of the present invention includes: a main body; an operating unit which is in non-contact with the main body; and a control unit which is disposed in the main body, and controls a motion of the object based on a relative position of the operating unit to the main body.

According to other aspects of the present invention, one or more sensors for outputting sensor values in accordance with the relative position with the operating unit are additionally included while the control unit may calculate the relative position of the operating unit with respect to the main body based on the sensor values obtained from the sensors.

According to another aspect of the present invention, the control unit may calculate and the relative position of the operating unit with respect to the main body based on a table written in advance to include the sensor values output from the sensors when the operating unit is in a specific position and sensor values obtained from the sensors.

According to another aspect of the present invention, the table may include multiple data sets matching a relative position value of the operating unit with respect to the main body when the operating unit is in a specific position and an estimated sensor value corresponding to the position value.

According to another aspect of the present invention, the control unit may, in the table, search for one or more similar data sets including an estimated sensor value similar to a sensor value obtained from the sensors, determine one of the similar data sets in accordance with a preset reference as a reference data set, and determine the position value of the reference data set as the relative position of the operating unit with respect to the main body.

According to another aspect of the present invention, the data set additionally includes an item related to a frequency value while the table may be generated by using a method including steps of positioning the operating unit on a sensor to have a preset position value, obtaining estimated sensor values from the sensor multiple times in the position, and increasing the frequency value of the data set including the estimated sensor values and the position value when equivalent estimated sensor values are obtained for the set position value.

According to another aspect of the present invention, the control unit may search for similar data sets based on sensor value similarity between the estimated sensor value and the sensor value obtained from the sensor.

According to another aspect of the present invention, the control unit may, in the table, select a data set with relatively high probability preferentially to search for a similar data set, wherein the data set with relatively high probability may be at least one data set including a frequency value higher than a preset value or at least one data set including a position value with positional continuity and the relative position of the operating unit with respect to the main body at one or more previous points.

According to still another aspect of the present invention, the control unit may search for a reference data set in the similar data sets while defining the reference data set as a data set including a position value with positional continuity with the relative position of the operation unit with respect to the main body at one or more previous point.

According to another aspect of the present invention, the control unit may determine one among the similar data sets with the largest frequency value as a reference data set.

According to another aspect of the present invention, the sensor value obtained from the sensor may be a sensor value reflecting an initial sensor value, which is a sensor value obtained from the sensor while the operating unit is removed from the main body, on a measurement sensor value, which is a sensor value obtained from the sensor while the operating unit is in the specific position.

According to another aspect of the present invention, the control unit may calculate the relative position of the operating unit with respect to the main body by determining the relative position of the operating unit having equivalent magnetic flux with respect to a sensor value obtained from the sensor based on a preset formula and limiting the tilting angle of the sensor and the operating unit.

Other detailed matters of the exemplary embodiment are included in the detailed description and the drawings.

### Advantageous Effects

According to at least one of the exemplary embodiments of the present invention, a motion of a three-dimensional moving object such as a drone may be controlled only by operating the controller, and as a result, it is possible to provide intuition to a user.

In addition, the moving object may be precisely controlled, and accuracy in controlling the moving object may be improved.

The additional scope of the applicability of the present invention will be clear from the following detailed description. However, various modifications and alterations within the spirit and the scope of the present invention may be clearly understood by those skilled in the art, and thus it should be understood that the particular exemplary embodiments such as the detailed description and the exemplary embodiments of the present invention are provided only for illustrative purposes.

### DESCRIPTION OF DRAWINGS

FIG. 1 is a schematic view illustrating an exemplary embodiment of an object controller in the related art.

FIG. 2 is a perspective view for explaining an object controller according to an exemplary embodiment of the present invention.

FIG. 3 is a block diagram for explaining the object controller according to the exemplary embodiment of the present invention.

FIG. 4 is a conceptual view for explaining a state in which the object controller in FIG. 2 recognizes a recognition region of an operating unit.

FIGS. 5A to 5D are conceptual views for explaining various examples of an operating method of controlling an object by using the object controller in FIG. 2.

FIGS. 6A and 6B are conceptual views for explaining a state in which operating units are accommodated in main bodies in object controllers according to different exemplary embodiments of the present invention.

FIGS. 7A to 7C are perspective views for explaining object controllers according to different exemplary embodiments of the present invention.

FIG. 8 is a conceptual view for explaining operating units according to different exemplary embodiments of the present invention.

FIG. 9 is a conceptual view for explaining an object controller according to another exemplary embodiment of the present invention.

FIG. 10 is a conceptual view for exhibiting a method of an object controller for determining the relative position of an operating unit with respect to a main body.

FIG. 11 is a conceptual view for illustrating an object which can be controlled by the object controller.

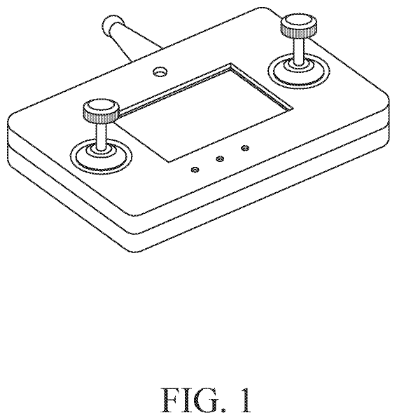

### BEST MODE

Advantages and features of the present invention and methods of achieving the advantages and features will be clear with reference to exemplary embodiments described in detail below together with the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention. Therefore, the present invention will be defined only by the scope of the appended claims.

The shapes, sizes, ratios, angles, numbers, and the like illustrated in the accompanying drawings for describing the exemplary embodiments of the present invention are merely examples, and the present invention is not limited thereto. Further, in the following description, a detailed explanation of known related technologies may be omitted to avoid unnecessarily obscuring the subject matter of the present invention. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is referred to as being “on” another element or layer, it may be directly on the other element or layer, or intervening elements or layers may be present.

Although the terms “first”, “second”, and the like are used for describing various components, these components are not confined by these terms. These terms are used only to distinguish one constituent element from another constituent element. Therefore, a first component to be mentioned below may be a second component in a technical concept of the present invention.

Throughout the specification, the same reference numerals denote the same constituent elements.

The size and thickness of each component illustrated in the drawings are shown for ease of description, but the present invention is not necessarily limited to the size and thickness of the illustrated component.

Respective features of several exemplary embodiments of the present invention may be partially or entirely coupled to or combined with each other, and as sufficiently appreciated by those skilled in the art, various technical cooperation and operations may be carried out, and the respective exemplary embodiments may be implemented independently of each other or implemented together correlatively.

Hereinafter, various exemplary embodiments of the present invention will be described in detail with reference to the accompanying drawings.

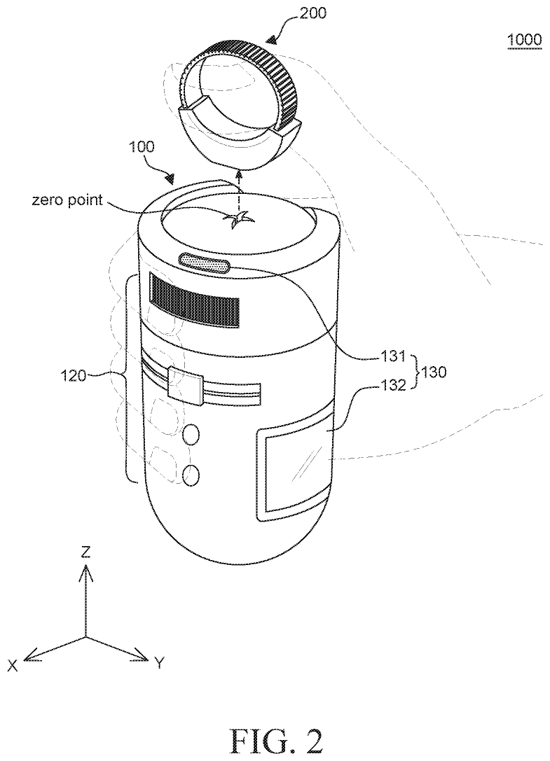

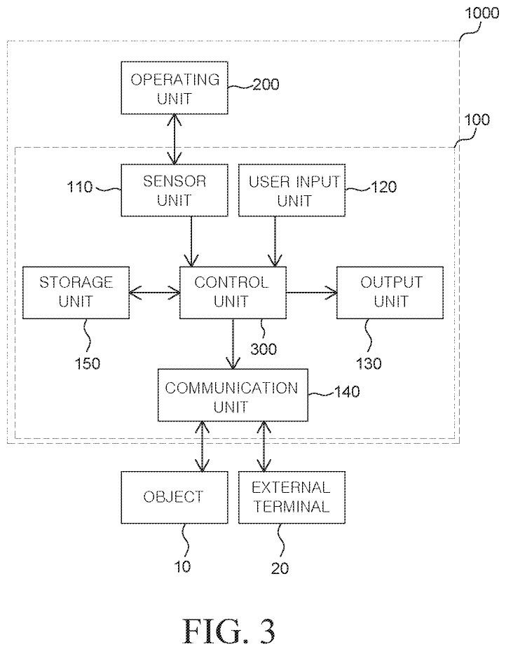

FIG. 2 is a perspective view for explaining an object controller according to an exemplary embodiment of the present invention. FIG. 3 is a block diagram for explaining the object controller according to the exemplary embodiment of the present invention.

An object controller 1000 of the present invention may control a motion of an object 10 to be controlled. Here, as the object 10 to be controlled, there are various objects such as drones, unmanned aerial vehicles, manned aerial vehicles, game consoles, objects in computer programs, and vehicles. However, in the present exemplary embodiment, the description will be made based on the drone.

Referring to FIGS. 2 and 3, the object controller 1000 includes a main body 100, an operating unit 200, and a control unit 300 which are operated in a state in which the main body 100, the operating unit 200, and the control unit 300 are not in contact with one another.

The main body 100 includes a sensor unit 110, a user input unit 120, an output unit 130, a communication unit 140, and a storage unit 150. In addition, the control unit 300 may be disposed in the main body 100. Meanwhile, a mark may be formed on a surface of an upper portion of the main body 100 so as to guide a region in which the operating unit 200 is disposed to be spaced apart from the upper portion of the main body 100 in a vertical direction.

The sensor unit 110 may be disposed an inner side close to one surface of the main body 100, specifically, an upper surface of the main body 100. The sensor unit 110, which is disposed in the main body 100, may measure a relative displacement with another sensor included in the operating unit 200. Based on the measured displacement, the control unit 300 may determine an operating signal to be transmitted to the object 10.

The user input unit 120 is disposed on the main body 100 so that a user may input a signal so as to perform another control on the object 10 in addition to the operation according to a relative position between the operating unit 200 and the main body 100. Specifically, the user input unit 120 may be used to input an operating signal for the object 10 which is not determined by a relative displacement between the operating unit 200 and the main body 100, calibrate a signal which is determined by a relative displacement between the operating unit 200 and the main body 100, or adjust a size and a ratio of a signal which is determined by a relative displacement between the operating unit 200 and the main body 100. An operating signal for the object 10 which is not determined by a relative displacement between the operating unit 200 and the main body 100 may be a signal for rotating the object 10.

Meanwhile, the user input unit 120 may be formed on a front surface of the main body 100 so that the user's fingers except for the thumb are disposed on the user input unit 120. However, the present invention is not limited thereto, and the user input unit 120 may be formed at other positions of the main body 100, or may be formed on the operating unit 200.

Further, the user input unit 120 may include at least one of a scroll button, a wheel button, a slide button, and a push button. Based on the drawing, the button positioned at an uppermost side is a wheel button, a slide button is positioned below the wheel button, and a push button is positioned below the slide button.

The output unit 130 means a configuration for outputting various signals generated by the control unit 300 so that the user may recognize the signals. The object controller 1000 may be used to guide the instructions through the output unit 130, or allow the user to recognize the type or a magnitude of a signal transmitted to the object 10. For example, the output unit 130 may be a light source such as an LED which emits light, a speaker 131 which outputs sound, a vibration module which vibrates the main body 100, and the like.

Meanwhile, a display 132 is one of the output unit 130. The display 132 may be disposed on the main body 100 so that the user may visually recognize the display 132. The display 132 may display information about the object 10, information about a control signal, and a signal for setting the main body 100.

The communication unit 140 may transmit and receive information about the object 10, information about a control signal, and a signal for setting the main body 100 to and from an external terminal 20. That is, the communication unit 140 may communicate with the object 10 of which the operation is controlled by the object controller 1000, or communicate with the external terminal 20 which may set or display information about the main body 100 and/or the object 10.

The storage unit 150 may store a relative initial position between the main body 100 and the operating unit 200 which is measured by the control unit 300, or calibration which is measured when the user performs an operation test based on the operating unit 200. In addition, the storage unit 150 may store signal systems, programs, and the like which may be used when the object controller 1000 operates other types of objects 10, for example, drones, unmanned aerial vehicles, manned aerial vehicles, game consoles, objects in computer programs, and vehicles.

The main body 100 may be formed to be held by a user with one hand. Referring to FIG. 2, the user may use the object controller 1000 with one hand. Specifically, the user may attach the operating unit 200 to the thumb, and may hold the main body 100 by using the remaining four fingers and the palm. The user may more easily control the object 10 with one hand by holding the object controller 1000 as described above. Meanwhile, the present invention is not limited to the aforementioned description, it is possible to use the operating unit 200 in a state in which the main body 100 is disposed on a floor or the like, or use the operating unit 200 with one hand by holding the main body 100 with the other hand.

The operating unit 200 may not be in contact with the main body 100, and the operating unit 200 may be moved in a state of being spaced apart from the main body 100. In this case, the control unit 300 may move the object 10 based on a relative position between the main body 100 and the operating unit 200.

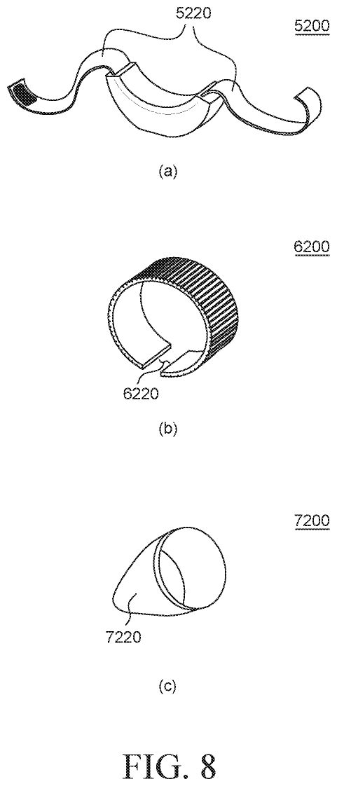

The operating unit 200 may be attached to the user's hand. Specifically, referring to FIG. 2, the operating unit 200 may be attached to the user's thumb. The operating unit 200 may be formed in a ring shape, but the shape of the operating unit 200 is not limited to the ring shape, and it is sufficient as long as any means, which may be attached to the user's hand, is provided. The operating unit 200 will be specifically described with reference to FIG. 8.

Meanwhile, a relative position between the operating unit 200 and the main body 100 may be detected by using a 3D magnetic sensor. Specifically, the 3D magnetic sensor may be embedded in the main body 100, and a magnet is embedded in the operating unit 200, such that the displacements of the main body 100 and the operating unit 200 may be recognized. In addition, a position sensor capable of detecting a relative position between the operating unit 200 and the main body 100 may be at least one of an acceleration sensor, a magnetic sensor, an impedance sensor, a hybrid sensor related to an impedance sensor and a magnetic sensor, a hybrid sensor, a gravity sensor (G-sensor), a gyroscope sensor, a motion sensor, an infrared (IR) sensor, an ultrasonic sensor, an optical sensor (e.g., camera).

The control unit 300 is disposed in the main body 100, and controls a motion of the object 10 based on a relative position of the operating unit 200 to the main body 100.

For example, the control unit 300 may set a relative initial position (zero point) between the operating unit 200 and one surface of the main body 100 based on the user's preset input inputted to the user input unit 120. Specifically, because the users may have different hand sizes, a position at which the operating unit 200 is comfortably placed on an upper portion of the main body 100 may vary when the user holds the main body 100 in a state in which the finger is inserted into the operating unit 200. In this case, the mark needs to be formed at a position where the operating unit 200 may be placed, but it may be difficult for the user to accurately dispose his/her operating unit 200 at the position. Therefore, when the user performs a preset input to the user input unit 120 in a state in which the operating unit 200 is comfortably disposed on the upper portion of the main body 100, the control unit 300 may recognize a relative distance between the operating unit 200 and the main body 100 at this time as a basic distance, that is, a relative initial position.

In addition, the control unit 300 sets a relative initial position of the operating unit 200 to the main body 100, and then may perform calibration, based on the relative initial position, on at least one of an X-axis, a Y-axis, and a Z-axis of the operating unit 200 in accordance with the preset input. Specifically, when the user slowly moves the finger in the X-axis, Y-axis, and Z-axis directions in a state of the relative initial position, the control unit 300 determines a displacement and a trajectory as the user's displacement and trajectory, and determines a control operation based on the user's displacement and trajectory.

Meanwhile, in a case in which the operating unit 200 and the upper portion of the main body 100 deviate from the preset displacement, the control unit 300 may generate a maintaining signal for maintaining the object 10 at the current position. Specifically, in some instances, the main body 100 may be withdrawn from the user's hand in a state in which the user wears the operating unit 200 on the finger. Because the main body 100 and the operating unit 200 are moved away from each other at a great displacement during a process in which the main body 100 falls, the control unit 300 may determine this situation as an upward movement signal of the drone if the drone is in operation. To prevent this situation, in a case in which the previously measured relative initial position and the calibrated value deviate from the preset value, it is possible to generate a maintaining signal, that is, a shut-down signal for still maintaining the object 10 at the position where the object 10 is positioned.

In addition, the control unit 300 may include a sync function for setting a control signal of the main body 100 so that the control unit 300 may communicate with other objects 10 so as to be able to control a new object 10 based on the user's preset input. Specifically, the operation may be performed by synchronizing the new object 10 (e.g., objects in computer programs, vehicles, etc.) with the object controller 1000. In this case, it is possible to synchronize the new object 10 and the object controller 1000 by performing the preset input to the user input unit 120.

In addition, based on the preset user input, the control unit 300 may set transmission of the communication unit 140 to an OFF state so as to maintain a hovering state of the object 10.

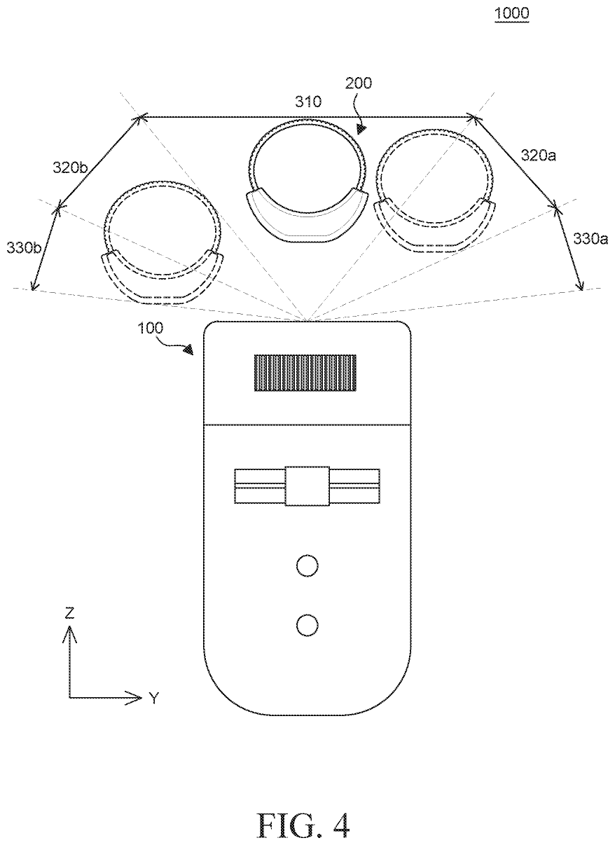

FIG. 4 is a conceptual view for explaining a state in which the object controller in FIG. 2 recognizes a recognition region of the operating unit.

Referring to FIG. 4, it can be seen that a region in which the operating unit 200 moves relative to the main body 100 is divided in the Y-axis direction. Because it is difficult to minutely adjust the operating unit 200 when the user moves the operating unit 200 in a state in which the user wears the operating unit 200, these regions are designated, and an output of the control unit 300 may be divided into several steps. The division of the region reduces a probability of malfunction caused by the user's unexperienced operation or fatigue.

The regions may be set by the user's calibration step. Specifically, a length of a finger or feeling displacement in respect to a movement varies for each user. Therefore, when the object controller 1000 is used, a step of setting a relative initial position and calibrating and storing stepwise displacements with respect to the X-axis, the Y-axis, and the Z-axis may be performed. A specific explanation is as follows.

The user wears the operating unit 200, and holds the main body 100. Thereafter, the user sets a relative initial position through the user input unit 120 or the like. After the relative initial position is set, the object controller 1000 may automatically request the user to set stepwise displacements with respect to the X-axis, the Y-axis, and the Z-axis. For example, the object controller 1000 may output an output “Please move to the right by one step.” to the user through the output unit 130. Thereafter, the object controller 1000 may output an output “Please move to the right by two steps.” through the output unit 130. Therefore, the user moves the operating unit 200 to the right by one step. Thereafter, the user moves the operating unit 200 to the right by two steps, that is, to the right further than the first step. By a method of repeating these processes, the regions with respect to the X-axis, the Y-axis, and the Z-axis may be set.

In more detail, settings of a first region 310, second regions 320 a and 320 b, and third regions 330 a and 330 b may vary in accordance with a size of the user's hand or the like. Therefore, the control unit 300 may perform the setting of the relative initial position and the calibration on the respective regions at the initial time when the object controller 1000 operates. The setting of the relative initial position and the calibration on the respective regions may be performed when a preset signal is inputted to the user input unit 120.

That is, the calibration of a signal determined by a relative displacement between the operating unit 200 and the main body 100 will be described below. The control unit 300 may set a relative initial position (zero point) between the operating unit 200 and one surface of the main body 100 based on the user's preset input inputted to the user input unit 120. After the relative initial position is set, the user may move the operating unit 200 with respect to at least one of the X-axis, the Y-axis, and the Z-axis of the operating unit 200. In this case, the sensor unit 110 and the control unit 300 may perform calibration by comparing a displacement of the operating unit 200 with the relative initial position.

Specifically, referring to FIG. 4, when the operating unit 200 is positioned in the first region based on the Y-axis, the control unit 300 may not generate a signal for moving the object 10 in the Y-axis direction. When the operating unit 200 is positioned in the second region, the control unit 300 generates a signal for moving the object 10 in the Y-axis direction at a predetermined speed. Further, when the operating unit 200 is positioned in the third region, the control unit 300 may generate a signal for moving the object 10 in the Y-axis direction at a speed higher than a movement speed generated in the second region. In this case, in a case in which the operating unit 200 is positioned in one region among the respective regions, the control unit 300 may generate a signal having the same magnitude for displacing the object 10. That is, when the operating unit 200 is positioned in one region, the control unit 300 outputs an output having the same magnitude, and thus, the object 10 may be moved.

Meanwhile, the region with respect to the respective axes may be divided into three or more regions or two regions. In addition, the region may be linearly set instead of being divided into a plurality of regions.

In addition, in a case in which a displacement with respect to one axis, among the X-axis, the Y-axis, and the Z-axis of the operating unit 200, is greater than displacements with respect to the remaining two axes by a preset range, the control unit 300 may set displacement values with respect to the two axes of the object 10 to 0. For example, when the user moves in a state in which the operating unit 200 is attached to the user's thumb, it is difficult for the operating unit 200 to linearly move with respect to the X-axis, the Y-axis, and the Z-axis due to a joint and a structure of the finger. Therefore, in a case in which a displacement with respect to one axis, among the X-axis, the Y-axis, and the Z-axis, is greater than displacements with respect to the remaining two axes by a preset range, the object 10 may be set to be moved only along the axis of which the displacement is greater than the preset range.

In this case, based on a calibration value, the control unit 300 generates a signal for moving the object 10 based on a displacement between the operating unit 200 and one side of the main body. However, the present invention is not limited thereto, the control unit 300 may generate a signal for moving the object 10 based on a reference value other than the calibration value. In this case, the reference value may be a value newly calculated by reflecting an error range to the calibration value.

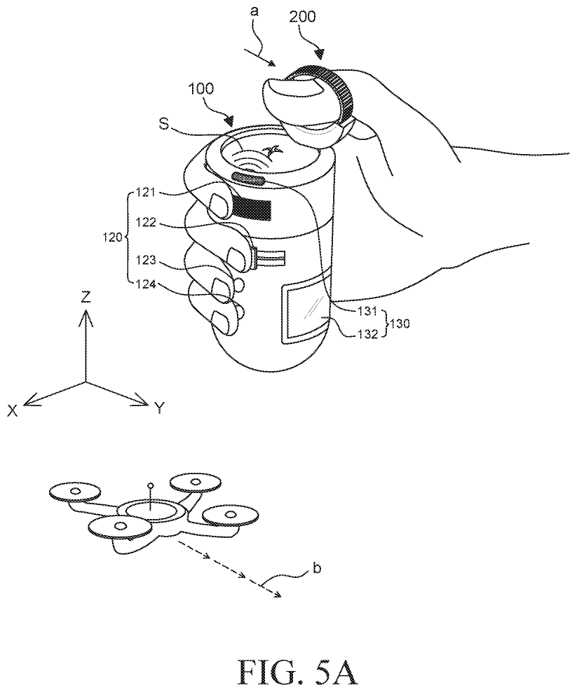

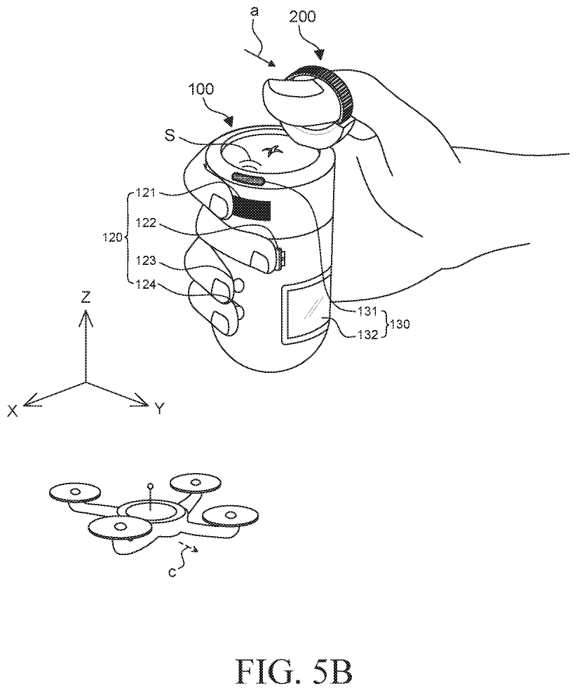

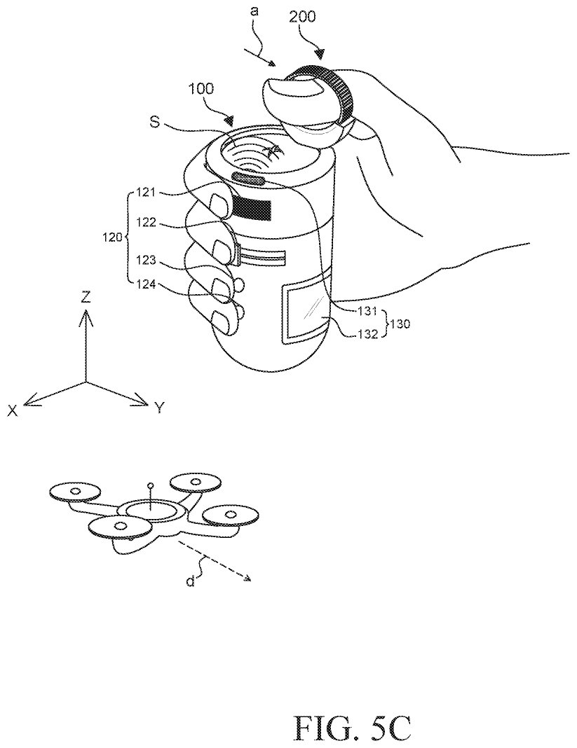

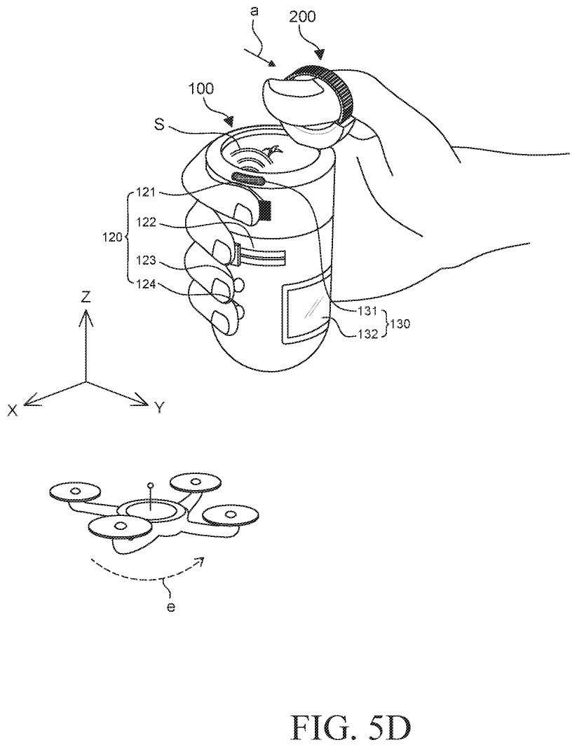

FIGS. 5A to 5D are conceptual views for explaining various examples of an operating method of controlling the object by using the object controller in FIG. 2.

First, FIG. 5A illustrates a state in which the object controller 1000 moves the object 10 in a relative coordinate mode. The user moves the operating unit 200 in a first direction by a vector value of the arrow a. In this situation, the object 10 is continuously moved in the first direction by the vector value of a. It may be considered that the object controller 1000 moves the object 10 in the relative coordinate mode.

Specifically, the operating unit 200 of the object controller 1000 is moved in the first direction by a distance of a in the relative coordinate mode. Therefore, the object 10 is moved in the first direction at a speed proportional to an absolute value of the distance of a (or a speed having a value to which a predetermined ratio is applied). That is, in the relative coordinate mode, the object 10 continuously travels at a speed proportional to a.

Next, FIGS. 5B and 5C illustrate a state in which the object controller 1000 moves the object 10 in an absolute coordinate mode. In both cases, the user moves the operating unit 200 in the first direction by the vector value of the arrow a. In this case, in FIG. 5B, the object 10 is moved in the first direction by a vector value of c. Further, in FIG. 5C, the object 10 is moved in the first direction by a vector value of d.

First, in the absolute coordinate mode, the object 10 is stopped after the object 10 is moved by an output corresponding to a degree to which the operating unit 200 is moved. Therefore, in FIG. 5B, the object 10 is stopped after the object 10 is moved in the first direction by the vector value of c. Further, in FIG. 5C, the object 10 is stopped after the object 10 is moved in the first direction by the vector value of d.

Further, based on the user's preset input to the user input unit 120, the control unit 300 may decrease or increase a ratio to a magnitude which displaces the object 10 which occurs in the respective regions. Specifically, the object 10 may be adjusted to be moved by a value made by applying a predetermined ratio to a relative displacement of the operating unit 200 in the user input unit 120. For example, when a second user input key 122 in FIG. 5B is pushed in any one direction, the object 10 may be moved by a relatively small vector value. Further, in FIG. 5C, the second user input key 122 is not pushed in any one direction. In this case, the object 10 may be moved by a vector value made by multiplying a distance, by which the operating unit 200 is moved, by a value relatively greater in comparison with a value in FIG. 5B.

Next, FIG. 5D illustrates a state in which the object 10 is rotated by using the object controller 1000. The control unit 300 may generate a signal for rotating the object 10 based on the user's preset input to the user input unit 120.

Specifically, a first user input key 121 is configured as a wheel key. In this case, when the wheel key is rotated, the object 10 may be rotated in the corresponding direction. Even in this case, the object controller 1000 may control the movement of the object 10 in the relative coordinate mode or the absolute coordinate mode.

The relative coordinate mode and the absolute coordinate mode may be changed when a predetermined operating method, among various operations such as a push operation, the number of push operations, a time for the push operation is applied to the first to fourth user input keys 121, 122, 123, and 124.

Meanwhile, to enable the user to easily recognize a magnitude of a signal for controlling the object 10, the control unit 300 may generate at least one of an acoustic signal, a visual signal, and a tactile signal which vary in accordance with a signal generated to control the object 10. That is, this change may be outputted through the output unit 130 so as to be recognized by the user. For example, in FIG. 5A, in the case of the relative coordinate mode, sound with middle intensity may be outputted through the speaker 131. In addition, in FIGS. 5B and 5C which illustrates the absolute coordinate mode, the intensity of sound may be determined to be correspond to a magnitude of the vector by which the object 10 is moved. In addition, in FIG. 5D which illustrates a rotation mode, sound may periodically occur. However, a visual output through the display 132 is enabled, and a tactile output using vibration is enabled.

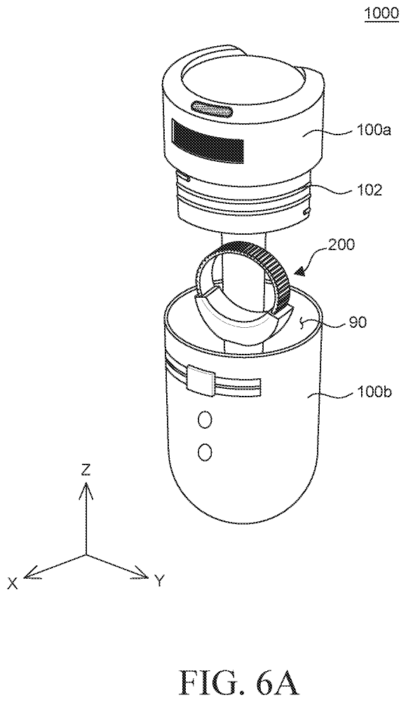

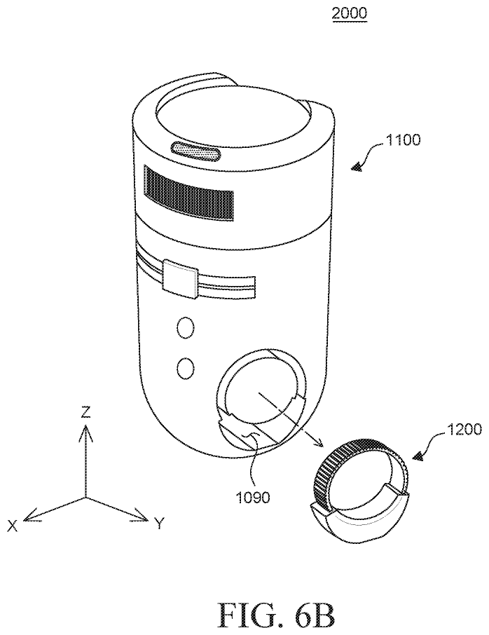

FIGS. 6A and 6B are conceptual views for explaining a state in which operating units are accommodated in main bodies in object controllers according to different exemplary embodiments of the present invention.

The main body 100 of the object controller 1000 of the present invention may include an accommodating space 90 which may accommodate the operating unit 200. Specifically, the accommodating space 90 may be formed in the main body 100 so as to accommodate the operating unit 200, or may be formed outside the main body 100 so that the operating unit 200 is detachably fitted with the accommodating space 90.

For example, referring to FIG. 6A, the main body 100 may be formed to be divided into an upper main body 100 and a lower main body 100. A screw thread is formed on the upper main body 100, such that the upper main body 100 may be coupled to or separated from the lower main body 100 by a relative rotation between the upper main body 100 and the lower main body 100. However, the present invention is not limited to the coupling manner.

When the upper main body 100 and the lower main body 100 are separated from each other, an internal space is formed in the lower main body 100. The operating unit 200 may be accommodated in the internal space. However, the present invention is not limited to the configuration in which the internal space is formed in the lower main body 100, and an internal space may be formed in the upper main body 100.

Next, referring to FIG. 6B, an accommodating space 1090 is recessed in the main body 1100 of the object controller 2000. The accommodating space 1090 may be formed corresponding to a shape of the operating unit 1200 so that the operating unit 1200 may be seated in the accommodating space 1090. In addition, an anti-withdrawal member may be further provided to prevent the operating unit 1200 from being easily withdrawn after the operating unit 1200 is seated and accommodated.

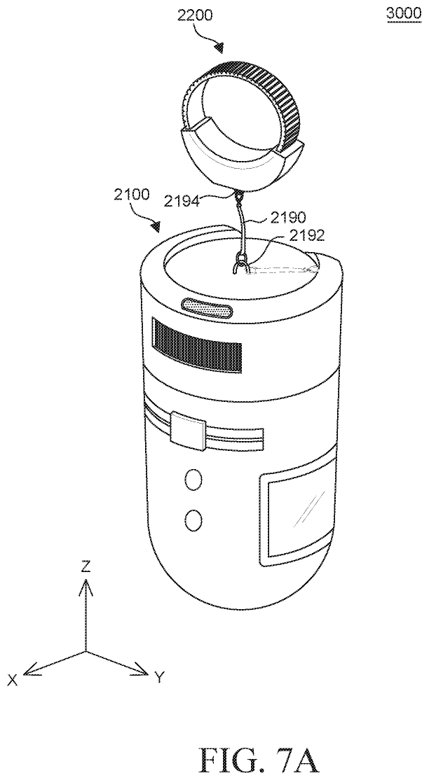

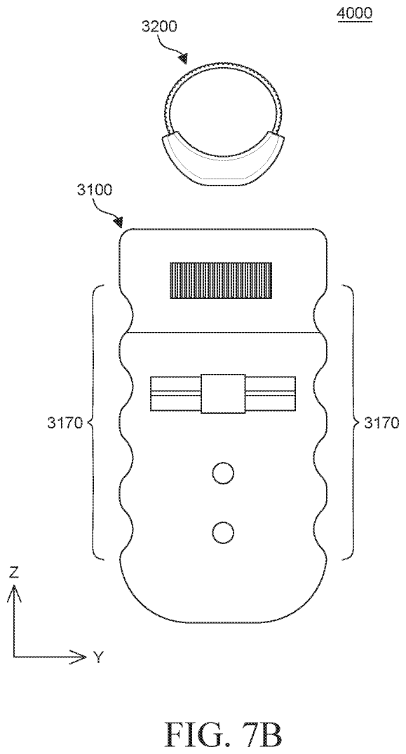

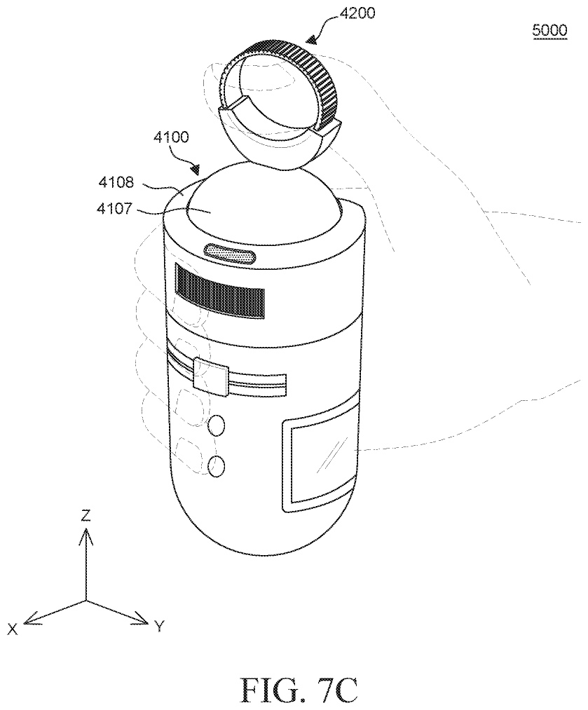

FIGS. 7A to 7C are perspective views for explaining object controllers according to different exemplary embodiments of the present invention.

First, referring to FIG. 7A, a main body 2100 may include a connecting member which may be formed on an upper surface of the main body 2100 and may be coupled to an operating unit 2200 so that the operating unit 2200 is not withdrawn from the main body 2100 while the operating unit is in operation. The connecting member may be connected to a loop formed on the upper surface of the main body 2100. The connecting member may be coupled to a loop formed on the operating unit 2200 as well as the loop formed on the upper surface of the main body 2100.

The control unit may generate a maintaining signal for maintaining the object 10 at the current position in a case in which the operating unit 2200 and the upper portion of the main body 2100 deviate from a preset displacement or greater or external force at preset pressure or higher is applied to the main body 2100. The reason is to prevent the object 10 from being operated by a relative distance between the operating unit 2200 and the main body 2100 which have fallen on the floor when the user simultaneously miss the main body 2100 and the operating unit 2200 because it is difficult for the operating unit 2200 to be separated from the main body 2100 because of the connecting loop.

Meanwhile, the connecting member may merely connect the operating unit 2200 and the main body 2100, but information about control of the object 10 may be obtained by pressure applied to the loop 2192 of the main body 2100.

To enable the user to easily hold the main body 3100, the main body 3100 may have a strap that surrounds the user's hand, or a curved portion may be formed on an external shape of the main body 3100. Specifically, referring to FIG. 7B, curved portions 3170 are formed on the main body 3100. The curved portion 3170 may not only guide a position at which the user's finger is positioned on the main body 3100, but also enable the user's hand and the main body 3100 to easily come into close contact with each other. That is, since the user's hand is inserted into the curved portion 3170 and comes into close contact with the curved portion 3170, and as a result, a contact area between the user's hand and the main body 3100 is increased. Furthermore, the finger inserted into the curved portion 3170 may receive force which causes the main body 3100 to fall down by gravity, and as a result, supporting force for supporting the main body 3100 may be increased.

Next, referring to FIG. 7C, an upper surface of a main body 4100 may convexly protrude toward the outside. The protruding surface is referred to as a support surface 4107. An operating unit 4200 may be movably supported on the support surface 4107. The user is spaced apart from an upper portion of the main body 4100 by the support surface 4107, and as a result, it is possible to reduce fatigue when the user operates the operating unit 4200. In addition, with the support surface 4107, it is possible to comparatively constantly maintain a separation distance between the operating unit 4200 and the main body 4100. In addition, elaboration may be increased when the user controls the object 10 by means of the operating unit 4200.

In addition, the support surface 4107 may be pushed when the support surface 4107 is pressed toward a central portion of the main body 4100 at a predetermined pressure or higher. That is, when the support surface 4107 is pressed toward the central portion of the main body 4100 (−Z-axis in the coordinate), the support surface 4107 itself may be pushed downward by a displacement to a designed predetermined degree. With the aforementioned operations of the operating unit 4200 and the support surface 4107, it is possible to generate a signal for moving the object 10 downward.

Meanwhile, the main body 4100 may include an anti-withdrawal projection which protrudes on the support surface 4107 along a circumference of the upper portion of the main body 4100. The anti-withdrawal projection prevents the operating unit 4200 from being moved to the outside of the main body 4100 while the operating unit 4200 is in operation.

FIG. 8 is a conceptual view for explaining operating units according to different exemplary embodiments of the present invention.

An operating unit 6200 of the present invention may include at least one of a holding means, a tightening means 5220, and a fitting means 7220 so that the operating unit 6200 may be attached to and detached from the user's finger.

First, FIG. 8A illustrates an exemplary embodiment in which the operating unit 6200 includes the tightening means 5220 configured as a strap. The user disposes the finger inside the operating unit 6200, and then connects and couples both sides of the tightening means 5220.

FIG. 8B illustrates an exemplary embodiment in which an operating unit 6200 holds the user's finger by pressing the user's finger by using restoring force. The operating unit 6200 has a ring shape which is partially cut out. A diameter of the operating unit 6200 is small, and as a result, the operating unit 6200 may hold the user's finger by using restoring force.

FIG. 8C illustrates an exemplary embodiment in which the operating unit 7200 includes a fitting means 7220 which may be tightened corresponding to a thickness of the user's finger.

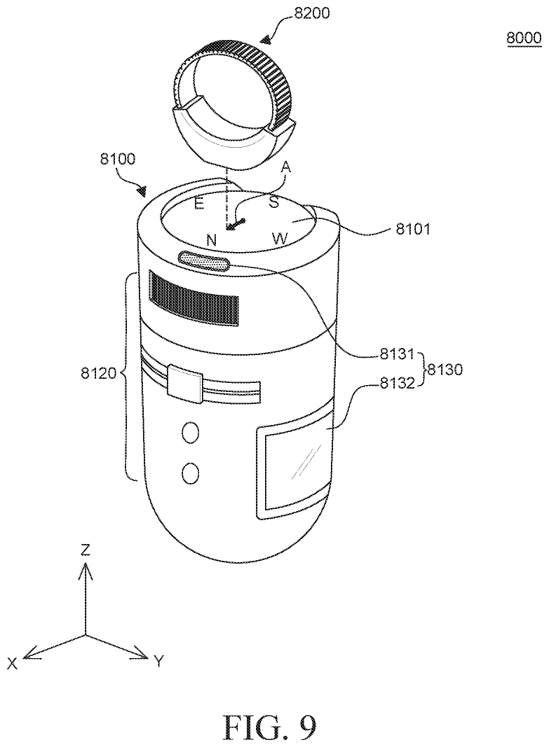

FIG. 9 is a conceptual view for explaining an object controller according to another exemplary embodiment of the present invention.

An upper surface display 8101 is disposed on an upper portion of the main body 8100, and information such as a position and a traveling direction of the operating unit 8200 may be displayed on the upper surface display 8101.

Specifically, referring to FIG. 9, the upper surface display 8132 is disposed on the upper portion of the main body 8100. A center point may be displayed on the display 8132. The center point is a dot which is displayed when the operating unit 8200 is disposed on the upper portion of the main body 8100.

In this case, a small size of the center point means a long vertical distance between the main body 8100 and the operating unit 8200, and a large size of the center point means a short vertical distance between the main body 8100 and the operating unit 8200. In a case in which a size of the center point is equal to or smaller than a predetermined size, that is, in a case in which a vertical distance between the main body 8100 and the operating unit 8200 is long, a signal for moving the object 10 upward may be transmitted. In a case in which a size of the center point is equal to or greater than a predetermined size, that is, in a case in which a vertical distance between the main body 8100 and the operating unit 8200 is short, a signal for moving the object 10 downward may be transmitted. In addition, an arrow A of the display 8132 may visually indicate a vector value in respect to a movement direction and a movement speed of the drone.

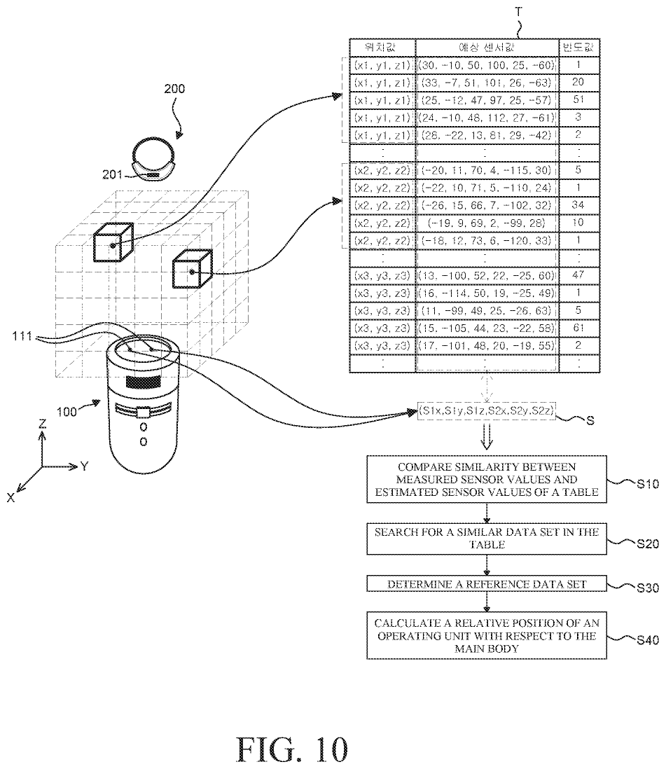

FIG. 10 is a conceptual view for exhibiting a method of an object controller for determining the relative position of an operating unit with respect to a main body.

An object controller 1000 of the present invention may include two sensors 111 for outputting a sensor value obtained in a sensing operation in accordance with a change in the distance to an operating unit 200 to a main body 100. When two or more sensors 111 are used, the relative position of the operating unit 200 with respect to the main body 100 can be calculated more accurately. The control unit 300 calculates the relative position of the operating unit 200 with respect to the main body 100 based on the sensor value obtained from the sensors 111.

The sensors 111 built in the main body 100 may be a 3D magnetic sensor while the operating unit 200 may have a magnetic unit 201 built therein. The sensors 111 may be any known sensor such as an ultraviolet sensor as described above but not limited thereto, but for convenience of explanation, it is assumed, hereinafter, that the sensors 111 are 3D magnetic sensors and that there is a magnetic unit 201 built in the operating unit 200.

A 3D magnetic sensor is a sensor which senses magnetic flux in X, Y, and Z directions and outputs a value. In FIG. 10, an output value of any one of the 3D magnetic sensors is referred to as S1x, S1y, and S1z while an output value of another magnetic sensor is referred to as S2x, S2y, and S2z.

The sensor 111 may be arranged on the upper part of the main body. A space, in which the operating unit is placed to be on the main body and the sensors 111 may sense the magnetic flux from the operating unit, may be partitioned into unit cells. Each of the unit cells has a center coordinate value determined with reference to a preset original point, such as a center point between two sensors. The relative position of the operating unit 200 with respect to the main body 100 may be determined by any one of coordinate values of the unit cells formed on the main body 100.

In the present embodiment, the virtual space and the unit cells are illustrated as a hexahedronal volume. However, this is merely an example, and it is also possible to transform the three-dimensional space and unit cells into spherical or other shapes.

Referring to FIG. 10, a control unit 300 calculates the relative position of an operating unit 200 with respect to a main body 100 based on a table T written in advance to include a sensor value output from a sensor when the operating unit 200 is arranged in a specific position and the sensor value S obtained from the sensor 111.

More specifically, the control unit 300 determines in which area of a virtual space a magnetic unit 201 of the operating unit 200 is arranged based on the sensor value (S) obtained from the sensor 111 and calculates the relative position of the operating unit 200 with respect to the main body 100 by using the center coordinate value of partitioned areas.

predetermined table T includes multiple data sets matching position values in a case where the magnetic unit is arranged in each of the partitioned spaces and estimated sensor values corresponding to the individual position values.

The table T can be generated in such a manner of obtaining sensor values from the 3D magnetic sensors while the magnetic unit is arranged in any one of the partitioned points and obtaining sensor values while moving the magnetic unit to all of the partitioned points. When the same sensor values are obtained for the same position values, the table can be generated by increasing the frequency value of the corresponding data set without storing a data set for the duplicates in the table. Thus, the table may include multiple data sets including position values, estimated sensor values, and frequency values.

Here, even when the magnetic unit is arranged in the same position from the sensors, the table includes multiple estimated sensor values different from each other with respect to any one of the position values, such as (x1, y1, z1), due to a change in the sensor values measured by the sensors within a predetermined range due to influences caused by factors such as a change in the inclination of a magnetic field axis or external geomagnetic factors involved therein.

A detailed description of a method employed by the control unit 300 of the object controller 1000 for calculating the relative position of the operating unit 200 with respect to the main body 100 is as follows:

When the magnetic unit 201 of the operating unit 200 is positioned at a certain point on the main body 100 by a user's operation, each of the sensors 111 detects a magnetic flux of a magnetic field generated by the magnetic unit 201 of the operating unit 200 flux and transmits the measured sensor values S to the control unit 300.

The control unit 300 determines the sensor value similarity between individual estimated sensor values stored in the table T and sensor values S obtained from the sensors in order to determine which one of the center coordinate values of the unit cells is closest to the magnetic unit 201 of the operating unit 200 (S10).

The sensor value similarity here may be determined by comparing the Manhattan distance or Euclidean distance of the estimated sensor values stored in the table T and the sensor values S obtained from the sensors, for an example.

The control unit 300 selects a data set including an estimated sensor value with high similarity with a sensor value S obtained from the sensors 111, based on the determination of similarity between the two sensor values, as a similar data set (S20).

When the similarity between the sensor values are determined based on the Manhattan distance or Euclidean distance, a data set including an estimated sensor value included in the preset Manhattan distance or Euclidean distance may be selected from the sensor values S as a similar data set.

When the similarity between sensor values S from the sensors 111 and estimated sensor value stored in the table T is high, a high probability of a match between the position value matching the estimated sensor value and real position of the magnetic unit 201 of the operating unit 200 may be indicated. Accordingly, the control unit 300 may select a data set including an estimated sensor value with high similarity with a sensor value S as a similar data set in order to use the same in calculation of the relative positions of the main body (100) and an operating unit (200).

On the other hand, when selecting a similar data set, the control unit 300 first selects a data set with relatively high probability in the table T preferentially for efficient data processing in order to select a similar data set with the relatively high probability among the data sets.

Here, the data set with relatively high probability is a data set including a position value with position continuity with the relative position of the operating unit 200 with respect to the main body at one or more previous points.

The positional continuity can be determined in consideration of the proximity with the position of the operating unit and the matching degree between the motion direction and orientation of the operating unit at previous points. For example, the positional continuity may be considered to be high when being simply adjacent to a previous position, or when a position maintains a traveling path in consideration of the traveling path which has been moving to the previous position.

For example, when the relative position of the operating unit with respect to the main body determined immediately beforehand is (x0, y0, z0), the control unit 300 determines a data set including a position value of (x1, y1, z1) as a data set with relatively high probability in order to select similar data sets. In this case, before determining the similarity between a sensor value obtained from the sensor and an estimated sensor value of another data set, the control unit executes similarity comparison between the sensor value obtained from the sensor and the estimated sensor value of the data sets including position values of (x1, y1, z1), thereby executing similarity determination on more probable estimated sensor values first.

On the other hand, a data set with relatively high probability may be a data set with a frequency value higher than a preset value.

In this case, the control unit may select a similar data set while using a data set with a frequency value higher than the preset value as a data set with relatively high probability. In this case, before determining the sensor value similarity between a sensor value obtained from sensors and an estimated sensor value of another data set, the control unit 300 executes similarity comparison between the sensor value obtained from the sensors and the estimated sensor value of the data set with a frequency value exceeding 30, thereby executing the similarity determination on more probable estimated sensor values first.

If a similar data set is searched by performing a partial search in data sets with relatively high probability and expanding the scope of the data set search, a highly reliable data set can be selected even without performing similarity determination on all estimated sensor values and sensor values, thereby increasing the data processing rate of the control unit 300.

Then, the control unit 300 determines one among one or more similar data sets as a reference data set in accordance with a preset reference (S30).

The predetermined reference for determining the reference data set in the similar data sets may be a reference for determining a data set including a position value with positional continuity with the relative position of the operating unit 200 with respect to the main body 100 at one or more previous points, and preferably, a point immediately before a current point as a reference data set.

Such determination references are based on the assumption that the relative position of the operating unit 200 with respect to the main body changes on a linear basis. Securing positional continuity is preferable in motion control of an object over more rapid changes in the relative position of the operating unit 200. Such reference for selecting reference data can enhance reliability when controlling object motion.

If one or more data sets still exist as similar data sets even after considering the position continuity, the control unit 300 may compare the frequency values of the individual similar data sets with each other in order to determine the data set with a high frequency value as a reference data set. If each and every data set has a position value with positional continuity, reliability in object motion control can be enhanced by selecting a data set with statistically high probability.

The control unit 300 calculates the position value of the determined reference data set as the relative position of the operating unit 200 with respect to the main body 100.

For example, a data set, which has a position value of (x2, y2, z2), a estimated sensor value of (−26, 15, 66, 7, −102, 32), and a frequency value of 34, in the table is determined as a reference data set, the control unit 300 may calculate the coordinate of (x2, y2, z2), which is the position value of the reference data set, as the relative position of the operating unit with respect to the main body.

On the other hand, sensor values (S) obtained from sensors before executing a method shown in FIG. 10 may be used after correction in order to determine the position of the operating unit while excluding external geomagnetic influences in an environment having the main body 100 and operating unit 200.

For example, the control unit 300 obtains an initial sensor value, which is a sensor value in a state where the operating unit 200 is removed from the main body 100, from the sensors 111, obtains a measurement sensor value, which is a sensor value in a state where the operating unit 200 is arranged on the main body 100, and calculates the relative position of the operating unit 200 with respect to the main body 100 based on a sensor value reflecting the initial sensor value on the measurement sensor value (such as a difference value between the initial sensor value and the measurement sensor value).

In addition, since the object controller of the present invention further includes a sensor only used for external geomagnetism measurement other than a sensor sensing the magnetic properties of the operating unit on the object controller, thereby enabling the control unit 300 to execute sensor value correction for excluding external geomagnetism influences.

In an above-described scheme, the control unit may determine in which area of a virtual space the magnetic unit 201 of the operating unit 200 is arranged based on the sensor values S obtained from the sensors 111 and the table T and calculate the relative position of the operating unit 200 with respect to the main body 100 by using positional values of the area.

Meanwhile, the control unit 300 may calculate the relative position of the operating unit 200 with respect to the main body 100 by using a preset formula not limited in the scheme described in FIG. 10.

The preset formula may be a formula configured to derive points having the equivalent magnetic flux based on sensor values S obtained from the sensors 111.

The principles that the control unit 300 calculates the relative position of the operating unit 200 with respect to the main body 100 using the preset formula is as follows:

When the magnet unit is located at an arbitrary distance from a sensor, the total amount of magnetic flux formed by the magnetic unit is independent of the angle between the sensor and the magnetic unit. Therefore, when the sensor obtains a sensor value in a measurement operation, the control unit may determine that the magnetic unit is arranged in a position on one point of a virtual spherical surface comprising points having the equivalent magnetic flux around the sensor.

If the control unit obtains sensor values from two sensors, the control unit may determine that the magnetic unit is arranged in a tangent area of two virtual spherical surfaces.

That is, the position of the magnetic unit estimated based on a sensor value (S1x, S1y, S1z) obtained from one of the two sensors may be arranged on a spherical surface comprising points having equivalent magnetic flux around the sensor, the position of the magnetic unit estimated based on a sensor value (S2x, S2y, S2z) obtained from the other one of the two sensors may be arranged on a spherical surface comprising points having equivalent magnetic flux around the other sensor. Accordingly, the control unit may determine, based on the sensor values obtained from the sensors, that the magnetic unit outputting the sensor values is arranged on the tangent line of the two spherical surfaces.

Since this calculation process of the control unit 300 may be represented by the preset formula, the control unit 300 may calculate the estimated area of the relative position of the operating unit 200 with respect to the main body 100 when sensor value S is obtained from sensor 111.

Furthermore, when the tilting angle of the magnetic unit 201 and sensor 111 (that is, the angle of the operating unit 200 held by a thumb to move on the main body 100) is restricted to be within a predetermined angle range, the precise point of the magnetic unit 201 of the operating unit 200 may be determined and the control unit 300 may calculate the relative position of the operating unit with respect to the main body.

Meanwhile, an object 10, which is used as a control target of an object controller 1000 according to the present invention, may be a physical object such as a drone, a unmanned aerial vehicle (UAV), a robot, a gaming device, or a model car described with reference to FIG. 5A to FIG. 5D but not limited thereto and may be an object in a program implemented in an apparatus such as a computer or a game console or an object in a 3D hologram image.

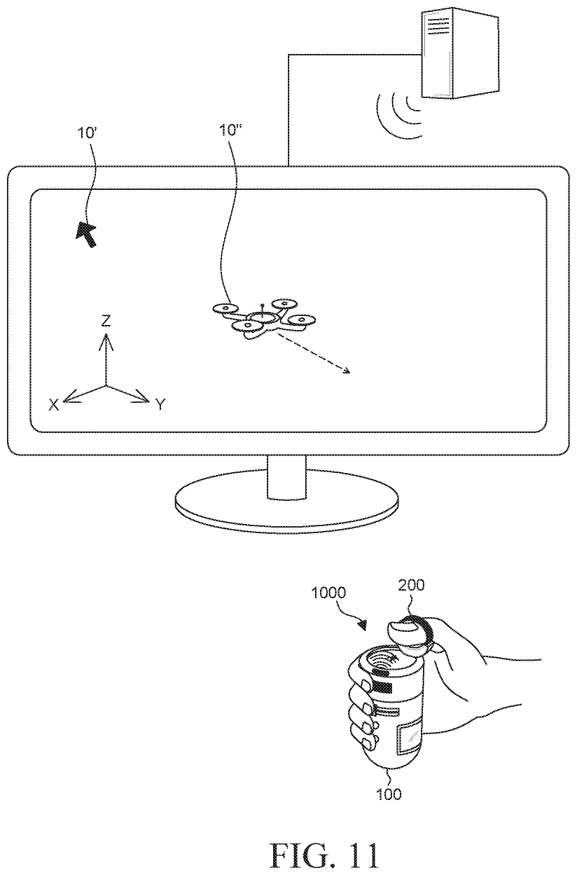

FIG. 11 is a conceptual view for illustrating an object which can be controlled by the object controller.

Referring to FIG. 11, objects (10′ 10″) controlled by an object controller can be an object which is implemented by a program and is displayed on the display device such as a monitor.

For example, the object 10′ may be a cursor or pointer of a mouse displayed on a display device. Here, the object controller 1000 of the present invention may be configured to server as an input device such as the mouse operating the curser or pointer. In another example, an object (10″) may be a character in a game displayed on a display device when a game program is executed by a computer. For example, the object 10″ may be an object of a drone image displayed on a display device if a drone flight game is executed by a computer, and the object controller 1000 of the present invention may be configured to serve as an input device for controlling the object.

When the objects 10′, 10″ are objects implemented by a program to be displayed on a display device such as a monitor, the object controller 1000 of the present invention may control the objects 10′, 10″ by using an above-described control method of the object controller 1000 in linkage with a control unit controlling an operation of the corresponding program.

It should also be understood that, of course, object controllers 2000, 3000, 4000, 5000, and 8000 according to various above-described embodiments may be employed without limitation to control the objects 10′, 10″.

Although the exemplary embodiments of the present invention have been described in detail with reference to the accompanying drawings, the present invention is not limited thereto and may be embodied in many different forms without departing from the technical concept of the present invention. Therefore, the exemplary embodiments of the present invention are provided for illustrative purposes only but not intended to limit the technical concept of the present invention. The scope of the technical concept of the present invention is not limited thereto. The protective scope of the present invention should be construed based on the following claims, and all the technical spirit in the equivalent scope thereto should be construed as falling within the scope of the present invention.

1. An object controller capable of controlling a motion of an object, the object controller comprising:
a main body;
an operating unit which is in non-contact with the main body; and
a control unit which is disposed in the main body, and controls a motion of the object based on a relative position of the operating unit to the main body.

2. The object controller of claim 1, including at least one sensor outputting a sensor value in accordance with a relative position of the operating unit, wherein the control unit calculates a relative position of the control unit with respect to the main body based on a sensor value obtained from the sensor.

3. The object controller of claim 2, wherein the control unit calculates a relative position of the operating unit with respect to the main body based on a predetermined table to include a sensor value output from a sensor when the operating unit is arranged in a specific position and a sensor value from the sensor.

4. The object controller of claim 3, wherein the table includes
multiple data sets matching a relative position value of the operating unit with respect to the main body when the operating unit is in a specific position and an estimated sensor value corresponding to the position value.

5. The object controller of claim 4, wherein the control unit
searches for one or more similar data sets including an estimated sensor value similar to a sensor value obtained from the sensor in the table, determines one of the similar data sets as a reference data set in accordance with preset references, and determines a position value of the reference data set as the relative position of the operating unit with respect to the main body.

6. The object controller of claim 5, wherein a data set additionally includes an item related to a frequency value, and wherein the table obtains estimated sensor values from the sensor multiple times after the operating unit is arranged on the sensor to have a preset position value, and increases the frequency value of a data set including the estimated sensor value and position value when equivalent estimated sensor values are obtained for the same position value.

7. The object controller of claim 5, wherein the control unit compares the sensor value similarity between the sensor value obtained from the sensor and the estimated sensor value to search for a similarity data set.

8. The object controller of claim 6, wherein the control unit searches for a similar data set by selecting a data set with relatively high probability in the table, and wherein the data set with relatively high probability is at least one data set with a frequency value higher than a preset value or at least one data set including a position value with positional continuity with the relative position of the operating unit with respect to the main body at one or more predetermined points.

9. The object controller of claim 5, wherein the control unit
searches for a reference data set in the similar data sets while defining the reference data set as a data set including a position value with positional continuity with the relative position of the operation unit with respect to the main body at one or more previous points.

10. The object controller of claim 6, wherein the control unit
determines a data set with the largest frequency value among the similar data sets as a reference data set.

11. The object controller of claim 5, wherein a sensor value obtained from the sensor is a sensor value reflecting an initial sensor value, which is a sensor value obtained from the sensor while the operating unit is removed from the main body, on a measurement sensor value, which is a sensor value obtained from the sensor while the operating unit is arranged in a specific position.

12. The object controller of claim 2, wherein the control unit calculates the relative position of the operating unit with respect to the main body by determining the relative position of the operating unit having the same magnetic flux based on a preset formula and a sensor value obtained from the sensor and limiting the tilting angle of the sensor and the operating unit.
